(19) United States
(12) Patent Application Publication
(10) Pub. No.: US 2011/0143066 A1
(43) Pub. Date: Jun. 16, 2011

(54) GAS BARRIER WITH ALIPHATIC RESIN

(75) Inventor: Linda M. Roddy, Fountain Inn, SC (US)

(73) Assignee: Michelin Recherche et Technique S.A.

(21) Appl. No.: 13/059,722

(22) PCT Filed: May 14, 2009
(86) PCT No.: PCT/US09/43948

§ 371 Date: Feb. 18, 2011

Related U.S. Application Data
(60) Provisional application No. 61/093,339, filed on Aug. 31, 2008.

(51) Int. Cl. B32B 25/18; B60C 1/00; C08L 65/00; C08L 95/00; C08L 9/00

(52) U.S. Cl. 428/35.4; 525/185; 524/68; 524/64

(57) ABSTRACT

A gas barrier layer constituted from a material based upon a rubber composition and a rubber article with a gas barrier layer constituted from a material based upon a rubber composition. The composition comprising, per 100 parts by weight of elastomer, a highly unsaturated diene elastomer, a butyl rubber, an aromatic hydrocarbon resin having a softening point of between 75° C. and 120° C. and an aliphatic hydrocarbon resin having a glass transition temperature greater than about 40° C. and a softening point of less than about 140° C.

### BACKGROUND OF THE INVENTION

1. Field of the Invention

This invention relates generally to gas-inflated articles and more specifically, to gas barriers that decrease the diffusion of the gas from the article.

2. Description of the Related Art

Various articles are constructed to be inflatable with a gas, such as air, and to hold the gas under pressure. Examples of such articles include tires, athletic balls such as basketballs, and footballs, inflatable boats and air mattresses. These articles are typically made from a polymeric material having some elastic properties; e.g., tires are typically made from an elastomeric rubber material, such as a styrene-butadiene polymer.

Many elastomeric materials that are used to make inflatable articles may, in some circumstances, remain slightly permeable to inflating gases. If left unchecked, the gas permeability of the inflated article may compromise the performance of the article and cause the article to deflate over time. Further, if oxygen is the permeating gas, the oxygen may cause oxidation of the elastomers with deleterious effects to the properties of the elastomer; e.g., the elastomers may tend to harden and degrade.

In view of the above, inflatable articles typically contain an inner liner that is intended to reduce gas permeability and, if the inflating gas is air, inhibit oxygen travel through the article. Typically these inner liners have been made from a composition containing butyl rubber. Butyl rubber in its raw state, however, still remains somewhat gas permeable so many attempts have been made to combine butyl rubber with other materials in order to further reduce its permeability.

### SUMMARY OF THE INVENTION

Particular embodiments of the present invention include a gas barrier layer constituted from a material based upon a rubber composition and a rubber article with a gas barrier layer constituted from a material based upon a rubber composition. The gas barrier layer may comprise, per 100 parts by weight of elastomer, a highly unsaturated diene elastomer, a butyl rubber, an aromatic hydrocarbon resin having a softening point of between 75° C. and 120° C. and an aliphatic hydrocarbon resin having a glass transition temperature greater than about 40° C. and a softening point of less than about 140° C.

The foregoing and other objects, features and advantages of the invention will be apparent from the following more detailed descriptions of particular embodiments of the invention.

### DETAILED DESCRIPTION OF PARTICULAR EMBODIMENTS

Particular embodiments of the present invention include gas barriers, compositions suitable for forming the gas barriers and elastomeric inflatable articles that hold a pressurized gas as an inflating gas, e.g., air, nitrogen, inert gases and the like. Gas barriers that are included as particular embodiments of the present invention may be incorporated into, for example, tires, sports equipment, such as sport balls, and in other articles in which an internal gas pressure must be maintained.

When incorporated into the wall of an elastomeric article, a barrier layer reduces the gas, vapor, and/or chemical permeability of the article. When incorporated into an inflatable article, a barrier layer not only improves the performance of the article by inhibiting gases from leaking out of the article, but also serves to protect the article from, for example, oxidation due to oxygen migration. In the description of the invention and examples disclosed herein, a reference to improvements or reduction in permeability means a lowering of the leak rate of gas, vapor, and/or chemicals from the article. The gas barrier layer may be formed as an inner liner of an article, an outer layer of an article or disposed between two or more other layers of an article. The article may be, inter alia, a tire. Particular embodiments of the present invention include tires having an inner liner formed with one or more of the rubber compositions disclosed herein.

Particular embodiments of the present invention include articles, including tires, having a gas barrier layer constituted from a material based upon a rubber composition having both an aromatic hydrocarbon resin and an aliphatic hydrocarbon resin. It has been found that the permeability of the gas barrier layer is significantly reduced by forming the barrier layer with a rubber composition having a combination of resins that includes both an aliphatic hydrocarbon resin and an aromatic hydrocarbon resin.

The term “based upon' as used herein recognizes that the barrier layers are made of vulcanized or cured rubber compositions that were, at the time of their manufacture, uncured. The cured rubber composition is therefore “based upon” the uncured rubber composition. In other words, the cross-linked rubber composition is based upon the cross-linkable rubber composition.

Particular embodiments of the rubber composition forming the gas barrier layer include a butyl rubber, an aromatic hydrocarbon resin having a softening point of between 75° C. and 120° C. and an aliphatic hydrocarbon resin having a glass transition temperature greater than about 40° C. and a softening point of less than about 140° C. Other embodiments may further include a highly unsaturated diene elastomer.

The rubber compositions disclosed herein that include both the aromatic hydrocarbon resin and the aliphatic hydrocarbon resin, when used in the manufacture of a gas barrier layer, provide a barrier layer having significantly reduced gas permeability. While each of these resins when used alone may, under appropriate applications, provide benefits to the physical properties of a rubber composition, it is the combination of these resins that result in the significant reduction in the gas permeability of the gas barrier layer manufactured from this new gas barrier composition without significant reduction of other favorable physical properties such as modulus and endurance properties. Particular embodiments of the present invention include no resins that have been modified with materials that provide additional functionality to the resins such as through grafting monomers having such functionality to the resin material.

Hydrocarbon resins are well known and are produced, for example, by the polymerization of various feeds, which may be pure monomer feeds or refinery streams containing mixtures of various unsaturated materials. Suitable aromatic hydrocarbon resins may also be produced as blended petroleum bitumen or asphalt. Particular embodiments may include blown asphalt. Phenolic resins may be particularly excluded from particular embodiments of the present invention.

The aromatic hydrocarbon resins useful for particular embodiments of the disclosed gas barrier are those having a softening point of between 75° C. and 120° C. or alternatively, between 80° C. and 115° C., between 85° C. and 110° C. or between 90° C. and 110° C. As described herein, the softening point is determined by the “Ring and Ball” method such as described in ASTM E-28.

Commercially available aromatic hydrocarbon resins suitable for use in particular embodiments of the gas barrier layer disclosed herein include, for example, STRUKTOL 40 MS flakes, available from Struktol Company of America of Ohio and PROMIX 750 available from Flow Polymers, Inc. of Ohio. STRUKTOL 40 MS is a mixture of aromatic hydrocarbon resins and may be characterized as having a softening point of between 135 and 150° C. PROMIX 750 is a blended petroleum bitumen product and may be characterized as having a softening point of between 85 and 95° C.

A suitable aliphatic hydrocarbon resin useful for particular embodiments of the gas barrier layer disclosed herein include those non-phenolic resins having a glass transition temperature greater than about 40° C. or alternatively greater than about 50° C. The resin may further be characterized for particular embodiments as having a softening point of less than about 140° C. or alternatively of between 75° C. and 120° C. between 80° C. and 115° C., between 85° C. and 110° C. or between 90° C. and 110° C. The glass transition temperature is measured by a differential scanning calorimeter (DSC) as provided by ASTM D3418-03/E1356-03. A suitable commercially available aliphatic hydrocarbon resin is the tackifying resin ESCOREZ 1102 available from ExxonMobil Chemical Company.

The aromatic hydrocarbon resin may be added to particular embodiments of the gas barrier layer at between 3 and 20 phr or alternatively between 3 and 10 phr or between 4 and 8 phr. The aliphatic hydrocarbon resin may be added to particular embodiments of the gas barrier layer at between 0.1 and 10 phr or alternatively between 0.1 and 8 phr, between 1 and 5 phr or between 1 and 4 phr.

The elastomer content of particular embodiments of the present invention includes a butyl rubber. In particular embodiments, for example, the elastomer may comprise a vinyl-based polymer. The elastomer may be a polymer represented by the following general formula:

[CH₂—C(R¹)(R²)]ₙ—

wherein R¹ and R² are independently hydrogen, an alkyl group, an aryl group, or an allyl group and wherein R¹ and R² may be the same or different.

The monomer used to form the above polymer may include, but is not limited to, ethylene, propylene, butadiene, isoprene, chloroprene, vinyl chloride, vinylidene chloride, vinyl fluoride, vinylidene fluoride, styrene, and alpha-methylstyrene.

In certain embodiments, the elastomer may have a polar functionality. For example, in one embodiment, the elastomer may be halogenated and may contain a halogen functional group such as bromine, chlorine, or fluorine.

Particular embodiments may include an elastomer that comprises epichlorohydrin polymers, which are available, for example, from Zeon Corporation under the trade name HYDRIN. These polymers are useful because, inter alia, they have lower gas permeability as desired in barrier layers.

The butyl rubber may be a butylene polymer or copolymer. For instance, the butylene may be a copolymer of isobutylene and isoprene (IIR). The butyl rubber may also be halogenated as described above. For example, the butyl rubber may be brominated or chlorinated. Examples of butyl rubbers that may be used in the present invention include brominated polyisobutylene isoprene copolymers (BIIR) or brominated isobutylene methyl styrene copolymers (BIMS). One commercially available BIMS elastomer that may be used in accordance with the present invention is EXXPRO available from the Exxon Corporation. Other commercially available butyl rubbers are available from the Bayer Chemical Corporation.

In addition to a butyl rubber, particular embodiments of the gas barrier layer disclosed herein may optionally include a highly unsaturated diene rubber. Diene elastomers or rubber is understood to mean those elastomers resulting at least in part (i.e., a homopolymer or a copolymer) from diene monomers (monomers bearing two double carbon-carbon bonds, whether conjugated or not). Essentially unsaturated diene elastomers are understood to mean those diene elastomers that result at least in part from conjugated diene monomers, having a content of members or units of diene origin (conjugated dienes) that are greater than 15 mol. %.

Thus, for example, diene elastomers such as butyl rubbers, nitrile rubbers or copolymers of dienes and of alpha-olefins of the ethylene-propylene diene terpolymer (EPDM) type or the ethylene-vinyl acetate copolymer type do not fall within the preceding definition, and may in particular be described as “essentially saturated” diene elastomers (low or very low content of units of diene origin, i.e., less than 15 mol. %). Particular embodiments of the present invention may include no nitrile rubbers or copolymers of dienes and of alpha-olefins of the ethylene-propylene diene terpolymer (EPDM) type or the ethylene-vinyl acetate copolymer type.

Within the category of essentially unsaturated diene elastomers are the highly unsaturated diene elastomers, which are understood to mean in particular diene elastomers having a content of units of diene origin (conjugated dienes) that is greater than 50 mol. %.

Suitable highly unsaturated diene elastomers include natural rubber, synthetic cis-1,4 polyisoprenes and mixtures thereof. These synthetic cis-1,4 polyisoprenes may be characterized as possessing cis-1,4 bonds at more than 90 mol. % or alternatively, at more than 98 mol. %. The highly unsaturated elastomer may be added in an amount of up to 30 phr (parts per hundred parts by weight of elastomer) or alternatively up to 20 phr, up to 15 phr, up to 10 phr or up to 5 phr. In particular embodiments, at least 1 phr of highly unsaturated diene elastomer is added up to the amounts disclosed above.

It should be noted that any of the elastomers may be utilized in particular embodiments as a functionalized elastomer. These elastomers can be functionalized by reacting them with suitable functionalizing agents prior to or in lieu of terminating the elastomer. Exemplary functionalizing agents include, but are not limited to, metal halides, metalloid halides, alkoxysilanes, imine-containing compounds, esters, ester-carboxylate metal complexes, alkyl ester carboxylate metal complexes, aldehydes or ketones, amides, isocyanates, isothiocyanates, imines, and epoxides. These types of functionalized elastomers are known to those of ordinary skill in the art. While particular embodiments may include one or more of these functionalized elastomers, other embodiments may include one or more of these functionalized elastomers mixed with one or more of the non-functionalized highly unsaturated elastomers.

Particular embodiments of the gas barrier and composition making up the gas barrier may further include any permeability reducing mineral fillers. Such permeability reducing mineral fillers are capable of reducing the gas permeability characteristics of a film or layer formed from the composition, thanks to its form, size or shape factor, generally known as “platy filler” (i.e., under the form of plates, platelets, layers, stacked layers or platelets, etc). Examples of fillers that may be used to reduce the gas permeability of the barrier layer include silicates, such as phyllosilicates. Such materials include, for example, smectite clay minerals and various other clay materials. Particular examples include kaolin, montmorillonite such as sodium montmorillonite, magnesium montmorillonite, and calcium montmorillonite, nontronite, beidellite, volkonskoite, hectorite, laponite, sauconite, sobockite, stevensite, svinfordite, vermiculite, mica, bentonite, sepeolite, saponite, and the like. Other materials that may be used include micaceous minerals such as illite and mixed layered illite/smectite minerals, such as ledikite and admixtures of illites and the clay minerals described above. Other suitable materials include graphite and/or glass flake, either alone or mixed with other permeability reducing mineral fillers.

In particular embodiments, an organo-modified filler may be used. For example, an organo-modified phyllosilicate may be incorporated into the composition of the present invention. In one particular embodiment, the organic structure to which the filler is associated is a surfactant. The surfactant may be represented by the following formula:

-M⁺R¹R²R³—

wherein M denotes nitrogen, sulfur, phosphorous or pyridinium, and R¹, R² and R³ independently denote hydrogen atoms, alkyl groups, aryl groups or allyl groups, which may be the same or different.

In particular embodiments of the present invention, for example, an organic modified montmorillonite based clay may be used. The montmorillonite clay may be organically modified with a surfactant such as dimethyl-dihydrogenated tallow-quaternary ammonium salt. An organically modified montmorillonite based clay as described above is commercially available from Southern Clay Products under the trade names CLOISITE 6A, 15A, and 20A. CLOISITE 6A, for instance, contains 140 meq/100 g clay of dimethyl dihydrogenated tallow quaternary ammonium salts. In addition to dimethyl-dihydrogenated tallow-quaternary ammonium salts, in other embodiments, the clay may also be organically modified with an octadecylamine or a methyl-tallow-bis-2-hydroxyethyl quaternary ammonium salt. Still other surfactants that may be used to modify the particles include dimethyl ditallow ammonium, dipolyoxyethylene alkyl methyl ammonium, trioctyl methyl ammonium, polyoxypropylene methyl diethyl ammonium, dimethyl benzyl hydrogenated tallow quaternary ammonium, dimethyl hydrogenated tallow 2-ethylhexyl quaternary ammonium, methyl dihydrogenated tallow ammonium, and the like. In addition to surfactant modification, the edges of montmorillonite clays may also be silane modified. For example, permeability reducing particles edge treated with silane agents are available under the trade name Nanomer I.31PS from Nanocor, Inc. of Arlington Heights, Ill.

In addition to montmorillonite based clays, the permeability reducing mineral fillers may comprise a synthetic mica (synthetic or natural), vermiculite, and bentonite based clay. Synthetic micas are commercially available from Co-Op Chemical Co., Ltd. under the trade name SOMASIF. Bentonite based clays are commercially available from Elementis Specialties/Rheox, Inc. under the trade name BENTONE.

The amount of the permeability reducing mineral fillers present in the composition depends generally on the particular particles selected and the materials they are being mixed with. In general, the permeability reducing mineral fillers may be present in the composition in an amount from about 1 to about 25 phr, such as from about 5 to about 20 phr. In an alternative embodiment, the particles may be present in the composition in an amount from about 3 to about 15 phr.

The invention is further illustrated by the following examples, which are to be regarded only as illustrations and not delimitative of the invention in any way. The properties of the compositions disclosed in the examples were evaluated as described below.

Moduli of elongation (MPa) were measured at 100% (MA 100) at a temperature of 23° C. based on ASTM Standard D412 on dumb bell test pieces. The measurements were taken in the second elongation; i.e., after an accommodation cycle. These measurements are secant moduli in MPa, based on the original cross section of the test piece.

Hysteresis losses (HL) were measured in percent by rebound at 60° C. at the sixth impact in accordance with the following equation:

HL(%)=100(W₀−W₁)/W₁,

where W₀ is the energy supplied and W₁ is the energy restored.

Gas permeability was measured using a MOCON OX-TRAN 2/61 permeability tester at 40° C. Cured sample disks of measured thickness (approximately 0.8-1.0 mm) were mounted on the instrument and sealed with vacuum grease. 10 psi of nitrogen was kept on one side of the disk, whereas 10 psi of 10% oxygen in nitrogen was on the other side. Using a Coulox oxygen detector on the nitrogen side, the increase in oxygen concentration was monitored. The oxygen concentration on the nitrogen side after reaching a constant value is recorded and used to determine the oxygen permeability.

Tensile strength was determined from dog bone shaped test samples cut from a cured plaque with a thickness of approximately 2.5 mm. The force and elongation at break was measured using an Instron 5565 Uniaxial Testing System. The cross-head speed was 500 mm/min. Samples were tested at ambient and at 60° C. and at 100° C. The tensile strength was defined as the product of the force at rupture divided by the initial cross-section area (MPa)* the elongation at break (%) divided by 100 and the area under the stress/strain curve measured as energy (J) to maximum force. The higher the index for a material, the less susceptible is the material to tearing.

### Example 1

Elastomer formulations were prepared using the components shown in Tables 1, 2, 3, and 4 and using procedures well known to one having ordinary skill in the art. The amounts of each component making up the elastomer formulations shown in the Tables are provided in parts per hundred parts by weight (phr) of the elastomer. The curative package included typical curing materials selected from one or more of sulfur, accelerator, zinc oxide, stearic acid and scorch retarder.

The elastomer formulations were prepared by mixing the components given in the Tables, in a Banbury mixer operating at 55-65 RPM until a temperature of between 120 and 170° C. was reached. Vulcanization was effected at 150° C. for 40 minutes.

TABLE 1
Formulations and Physical Properties

| | W1 | F1 | W2 | F2 | F3 |
|---|---|---|---|---|---|
| Natural Rubber | 15 | 15 | 10 | 10 | 10 |
| Butyl Rubber | 85 | 85 | 90 | 90 | 90 |
| Carbon Black | 58 | 58 | 48 | 48 | 48 |
| Process Oil | 2 | 2 | | | |
| Kaolin Clay | 10 | 10 | 14 | 14 | 14 |
| Tackifier | 2 | 0 | 2 | 0 | 2 |
| STRUKTOL 40MS | 6 | 6 | 6 | 6 | 6 |
| Escorez 1102 | 0 | 2 | 0 | 2 | 0 |
| Cure Package | 4 | 4 | 4.2 | 4.2 | 4.2 |
| MA 100, MPa | 1.05 | 0.94 | 1.07 | 1.06 | 1.06 |
| Hysteresis Loss, % | 38 | 37 | 40.4 | 39.6 | 40.4 |
| Permeability | 198 | 177 | 149 | 122 | 152 |

Surprisingly, as can be seen in the results shown in Table 1, the addition of both the aliphatic hydrocarbon resin and the aromatic hydrocarbon resin provided a significant decrease in the permeability of the barrier layer.

TABLE 2
Formulations and Physical Properties

| | W3 | F4 | F5 | F6 |
|---|---|---|---|---|
| Natural Rubber | 10 | 10 | 10 | 10 |
| Butyl Rubber | 90 | 90 | 90 | 90 |
| Carbon Black | 58 | 58 | 58 | 58 |
| Process Oil | 6 | 0 | 0 | 0 |
| Kaolin Clay | 10 | 10 | 10 | 10 |
| Tackifier | 2 | 2 | 0 | 0 |
| STRUKTOL 40MS | 0 | 6 | 6 | 0 |
| Escorez 1102 | 0 | 0 | 2 | 8 |
| Cure Package | 5.7 | 5.7 | 5.7 | 5.7 |
| MA 100, MPa | 1.38 | 1.23 | 1.23 | 1.36 |
| Hysteresis Loss, % | 33.2 | 39.1 | 37.6 | 32.2 |
| Permeability | 185 | 157 | 146 | 135 |
| Elongation at Break, % | 521 | 658 | 636 | 526 |
| Energy at Break (J) | 11.5 | 14.6 | 14.3 | 12.5 |

As can be seen in Table 2, the combination of the aliphatic hydrocarbon resin and aromatic hydrocarbon resin, represented as formulation F5, provides a decrease in the permeability of the barrier layer without compromising the elongation properties. The aliphatic resin only sample, represented as formulation F6 produces even more of a decrease in the permeability of the barrier layer, however; the elongation properties are compromised.

TABLE 3
Formulations and Physical Properties

| | F7 | F8 | F9 | F10 |
|---|---|---|---|---|
| Natural Rubber | 10 | 10 | 10 | 10 |
| Butyl Rubber | 90 | 90 | 90 | 90 |
| Carbon Black | 48 | 48 | 48 | 48 |
| Process Oil | 1.5 | 1.5 | 1.5 | 1.5 |
| Kaolin Clay | 10 | 10 | 10 | 10 |
| Tackifier | 3 | 0 | 3 | 0 |
| STRUKTOL 40MS | 6 | 6 | 0 | 0 |
| Escorez 1102 | 0 | 3 | 0 | 3 |
| Promix 750 | 0 | 0 | 6 | 6 |
| Cure Package | 4.2 | 4.2 | 4.2 | 4.2 |
| MA 100, MPa | 0.96 | 1.03 | 0.91 | 0.95 |
| Hysteresis Loss, % | 36.8 | 35.1 | 39.1 | 37.3 |
| Permeability | 170 | 156 | 177 | 155 |
| Elongation at Break, % | 461 | 421 | 524 | 426 |
| Energy at Break (J) | 17.3 | 12.2 | 17.8 | 17.2 |

Again, as shown in Table 3, the combination of an aliphatic hydrocarbon resin and an aromatic hydrocarbon resin, as represented by formulations F8 and F10, provides a significant decrease in the permeability of the barrier layer when compared to an aromatic hydrocarbon resin and tackifying resin combination.

TABLE 4
Formulations and Physical Properties

| | W4 | W5 | F11 | F12 |
|---|---|---|---|---|
| Natural Rubber | 10 | 10 | 10 | 10 |
| Butyl Rubber | 90 | 90 | 90 | 90 |
| Carbon Black | 48 | 48 | 48 | 48 |
| Process Oil | 2 | 0 | 0 | 0 |
| Kaolin Clay | 10 | 10 | 10 | 10 |
| Tackifier | 0 | 2 | 0 | 0 |
| STRUKTOL 40MS | 6 | 6 | 6 | 6 |
| Escorez 1102 | 0 | 0 | 2 | 0 |
| C5-C9 resin | 0 | 0 | 0 | 2 |
| Cure Package | 5.2 | 5.2 | 5.2 | 5.2 |
| MA 100, MPa | 1.04 | 1.01 | 1.02 | 1.04 |
| Hysteresis Loss, % | 34.7 | 38.1 | 35.9 | 36.0 |
| Permeability | 136 | 156 | 115 | 125 |
| Elongation at Break, % | 723 | 719 | 700 | 720 |
| Energy at Break (J) | 18.1 | 16.8 | 16.8 | 17.8 |

And again, as shown in Table 4, the combination of an aliphatic hydrocarbon resin and an aromatic hydrocarbon resin, as represented by formulation F11, provides a significant decrease in the permeability of the barrier layer when compared to an aromatic hydrocarbon resin and tackifying resin combination and the aromatic resin alone.

The terms “comprising,” “including,” and “having,” as used in the claims and specification herein, shall be considered as indicating an open group that may include other elements not specified. The term “consisting essentially of,” as used in the claims and specification herein, shall be considered as indicating a partially open group that may include other elements not specified, so long as those other elements do not materially alter the basic and novel characteristics of the claimed invention. The terms “a,” “an,” and the singular forms of words shall be taken to include the plural form of the same words, such that the terms mean that one or more of something is provided. The terms “at least one” and “one or more” are used interchangeably. The term “one” or “single” shall be used to indicate that one and only one of something is intended. Similarly, other specific integer values, such as “two,” are used when a specific number of things is intended. The terms “preferably,” “preferred,” “prefer,” “optionally,” “may,” and similar terms are used to indicate that an item, condition or step being referred to is an optional (not required) feature of the invention. Ranges that are described as being “between a and b” are inclusive of the values for “a” and “b.”

It should be understood from the foregoing description that various modifications and changes may be made to the embodiments of the present invention without departing from its true spirit. The foregoing description is provided for the purpose of illustration only and should not be construed in a limiting sense. Only the language of the following claims should limit the scope of this invention.

What is claimed is:

1. A gas barrier layer constituted from a material based upon a rubber composition, the composition comprising, per 100 parts by weight of elastomer:
a highly unsaturated diene elastomer;
a butyl rubber;
an aromatic hydrocarbon resin having a softening point of between 75° C. and 120° C.; and
an aliphatic hydrocarbon resin having a glass transition temperature greater than about 40° C. and a softening point of less than about 140° C.

2. The gas barrier layer of claim 1, wherein the aromatic hydrocarbon layer comprises petroleum bitumen.

3. The gas barrier layer of claim 2, wherein the petroleum bitumen comprises blown asphalt.

4. The gas barrier layer of claim 1, wherein the aromatic hydrocarbon resin is an homogenizing agent.

5. The gas barrier layer of claim 1, wherein the aromatic hydrocarbon resin has a softening point of between 85° C. and 110° C.

6. The gas barrier layer of claim 1, wherein the aromatic hydrocarbon resin content is between 3 and 20 phr.

7. The gas barrier layer of claim 1, wherein the aromatic hydrocarbon resin content is between 3 and 10 phr.

8. The gas barrier layer of claim 1, wherein the aromatic hydrocarbon resin content is between 4 and 8 phr.

9. The gas barrier layer of claim 1, wherein the aliphatic hydrocarbon resin content is between 0.1 and 10 phr.

10. The gas barrier layer of claim 1, wherein the aliphatic hydrocarbon resin content is between 1 and 5 phr.

11. The gas barrier layer of claim 1, wherein the aliphatic hydrocarbon resin content is between 1 and 4 phr.

12. The gas barrier layer of claim 1, wherein the highly unsaturated diene elastomer content is up to 30 phr.

13. The gas barrier layer of claim 1, wherein the highly unsaturated diene elastomer content is up to 15 phr.

14. The gas barrier layer of claim 1, wherein the highly unsaturated diene elastomer content is between 1 and 10 phr.

15. The gas barrier layer of claim 1, wherein the highly unsaturated diene elastomer is natural rubber.

16. A rubber article with a gas barrier layer constituted from a material based upon a rubber composition, the composition comprising, per 100 parts by weight of elastomer:
a highly unsaturated diene elastomer in an amount up to 30 phr;
a butyl rubber;
an aromatic hydrocarbon resin having a softening point of between 75° C. and 120° C. in an amount between 3 and 20 phr; and
an aliphatic hydrocarbon resin having a glass transition temperature greater than about 40° C. and a softening point of less than about 140° C. in an amount between 0.1 and 10 phr.

17. The rubber article of claim 16, wherein the rubber article is a tire.

18. The rubber article of claim 16, wherein the aromatic hydrocarbon resin content is between 4 and 8 phr.

19. The rubber article of claim 16, wherein the aliphatic hydrocarbon resin content is between 1 and 4 phr.

20. The rubber article of claim 16, wherein the highly unsaturated diene elastomer content is between 1 and 10 phr.
